(19) United States
(12) Patent Application Publication
(10) Pub. No.: US 2026/0269648 A1
(43) Pub. Date: Sep. 10, 2026

(54) SERVER, EXPANSION DEVICE, AND POWER SOURCE CONTROL METHOD OF THE EXPANSION DEVICE

(71) Applicant: NTT, Inc., Tokyo (JP)

(72) Inventors: Hikaru HARASAWA, Tokyo (JP); Kei FUJIMOTO, Tokyo (JP); Shogo SAITO, Tokyo (JP)

(73) Assignee: NTT, Inc., Tokyo (JP)

(21) Appl. No.: 19/161,780

(22) PCT Filed: Mar. 8, 2023
(86) PCT No.: PCT/JP2023/008774

§ 371 Date: Sep. 3, 2025

(51) Int. Cl. H02J 13/34

(52) U.S. Cl. CPC H02J 13/34

(57) ABSTRACT

A server includes: a CPU that executes an application; and an expansion device that is supplied with first power different from second power supplied to the CPU and has a function unit for adding a function to the server. The expansion device includes: a plurality of power lines for supplying the expansion device with the first power, one or more power lines of the plurality of power lines used to supply power to the function unit; a power controller configured to perform on/off control of the function unit separately for the one or more power lines in response to a request from the application; and one or more switches provided respectively on the one or more power lines, each of the one or more switches configured to switch between supply and shutoff of power inputted to the respective power line upon reception of a control signal from the power controller.

CROSS-REFERENCE TO RELATED APPLICATION

This is a National Stage Application of PCT Application No. PCT/JP2023/008774, filed on Mar. 8, 2023. The disclosure of the prior application is considered part of the disclosure of this application, and is incorporated in its entirety into this application.

### TECHNICAL FIELD

The present invention relates to a server, an expansion device, and a power control method for an expansion device.

### BACKGROUND ART

In computer systems, there is a configuration in which an expansion device such as an accelerator (hereinafter referred to as an ACC as appropriate) or a network interface card (NIC) is connected to a computer (hereinafter referred to as a server).

In the concept of virtual radio access network (vRAN) system, it is assumed that processing by a general server is performed using not only a Central Processing Unit (CPU) but also an expansion device such as a Field Programmable Gate Array (FPGA)/(“/” represents “or” in the following description) a Graphics Processing Unit (GPU)/an Application Specific Integrated Circuit (ASIC).

In the concept of vRAN system, it is assumed that the processing by a general server is performed using not only a CPU but also an expansion device such as an accelerator or a GPU.

In particular, as an expansion device consumes a large amount of power, reduction of the power consumption is a matter of concern.

Conventional techniques for saving power of an expansion device include the following.

FIG. 11 is a diagram for explaining power control in Peripheral Component Interconnect-Express (PCI-Express, hereinafter referred to as PCIe as appropriate) hot plugging (Non-Patent Literature 1).

Server 1 includes: motherboard 10 on which CPU 11, hot-plug controller 12, and extension bus 13 are mounted; expansion device 20 on which computing unit 21 is mounted; and power unit 30 that supplies power to motherboard 10.

Server 1 includes one or more expansion devices 20. Expansion device 20 is an expansion card of an accelerator, a GPU, or the like.

Existing servers 1 that support the PCIe hot plugging function are capable of dynamically shutting off the power supply to a certain bus. However, there are the following points to note as the paths and devices to which the power supply can be shut off are limited and the shutting off cannot be applied to a server without the power control mechanism.

Hot-plug controller 12 dynamically shuts off the power supply by software. Moreover, hot-plug controller 12 shuts off a plurality of power supplies “collectively” (reference sign “a” in FIG. 11). As it is possible to shut off the power supply to the entire card, the requirement for minimizing the standby power consumption is satisfied. On the other hand, as it is limited to devices supporting PCIe hot plugging, host machine independency, that is, versatility is not satisfied.

FIG. 12 is a diagram for explaining power control of a laptop personal computer (PC).

As a technique for a GPU of a laptop PC, there is a technique of cutting off power supply to the GPU when not in use (e.g., refer to https://www.nvidia.com/en-us/geforce/technologies/optimus/technology/; corresponding to Non-Patent Literature 1 cited as an implementation example of PCIe Hot plugging).

Laptop PC 2, in which an external GPU is installed, includes GPU driver 41 and Advanced Configuration and Power Interface (ACPI) 42 on OS 40, and includes CPU 51, GPU (on-board) 52, and power controller 53 on motherboard 50.

Laptop PC 2, in which an external GPU is installed, supplies power to the external GPU (GPU 52) only when high performance is required (such as in a game).

GPU driver 41 controls GPU 52 and performs power supply control of GPU 52 using ACPI 42.

ACPI 42 consults ACPI table 60 to control the power state (use of an AC adapter or a battery), the temperature, and the GPU power supply, for the PC main body. ACPI table 60 is initialized at the time of start-up by a Basic Input Output System (BIOS). As ACPI 42 strongly depends on the implementation of the BIOS, it is necessary to design the PC main body on the premise that the present technique is implemented therein. Thus, the requirement of host machine independency is not satisfied. That is, similarly to server 1 supporting the PCIe hot plugging illustrated in FIG. 11, as the implementation of the BIOS depends on the host machine, ACPI 42 does not satisfy the requirement of host machine independency. Moreover, as laptop PC 2, in which an external GPU is installed, is a PC of a dedicated design with the GPU installed, the requirement of host machine independency is not satisfied also in this regard.

On the other hand, power controller 53, upon reception of an instruction from ACPI 42, shuts off the power supply to GPU (on-board) 52 (reference sign “b” in FIG. 12). Power controller 53 combines on/off of GPU 52 by power supply control and the power control function of GPU 52 itself to optimize power according to demands. Thus, the requirement for minimizing the standby power consumption is satisfied.

### CITATION LIST

### Non-Patent Literature

Non-Patent Literature 1: PRIMECLUSTER Global Link Services Setsumeisho 4.1 (Densoro Nijukakinou Hen) (Linux) (in Japanese) (PRIMECLUSTER Global Link Services Guide 4.1 (transmission path duplexing function edition) (Linux)), [online], [retrieved on Feb. 11, 2023], the Internet <https://software.fujitsu.com/jp/manual/manualfiles/M050011/J2UZ5341/06Z2B/hanet05/hanet1 09.htm>

### SUMMARY OF THE INVENTION

### Problems to be Solved by the Invention

However, as described with reference to FIGS. 11 and 12, as the power saving of expansion devices depends on the specifications of the servers and interfaces, there is a problem in that it cannot be generally used.

That is, the problem is to achieve the power control by the expansion device alone without depending on the specifications of the computing circuitry and/or the specifications of the server (requirement 1: host machine independency) and to minimize the power consumption of the expansion device with respect to a use request from the application (requirement 2: power saving).

The present invention has been made in view of such a background, and an object of the present invention is to reduce the power consumption of an expansion device without depending on the implementations of servers and while securing the performance required from application programs.

### Solution to Problem

In order to solve the above-described problem, there is provided a server including: a central processing unit (CPU) that executes an application program; and an expansion device that is supplied with first power different from second power supplied to the CPU and has a function unit for adding a function to the server, wherein the expansion device includes: a plurality of power lines for supplying the expansion device with the first power, one or more power lines of the plurality of power lines used to supply power to the function unit; a power controller configured to perform on/off control of the function unit separately for the one or more power lines in response to a request from the application program; and one or more switches provided respectively on the one or more power lines, each of the one or more switches configured to switch between supply and shutoff of power inputted to the respective power line upon reception of a control signal from the power controller.

### Advantageous Effects of Invention

According to the present invention, it is possible to reduce the power consumption of an expansion device without depending on the implementations of servers and while securing the performance required from application programs.

### BRIEF DESCRIPTION OF THE DRAWINGS

FIG. 1 is a schematic configuration diagram of a power control system according to a first embodiment of the present invention.

FIG. 2 is a diagram of the power control system in FIG. 1, in the perspective of software operating on a CPU of a server.

FIG. 3 is a table illustrating examples of power states of a PCIe slot power supply and an extension connector power supply of the server according to the first embodiment of the present invention.

FIG. 4 is a diagram illustrating an expansion device that uses PCIe and SMBus of the server according to the first embodiment of the present invention.

FIG. 5 is a diagram illustrating an expansion device that uses PCIe of the server according to the first embodiment of the present invention.

FIG. 6 is a flowchart illustrating a procedure of processing of transitioning to a power saving state (power on→off) of the server according to the first embodiment of the present invention.

FIG. 7 is a flowchart illustrating a procedure of processing of returning from a power saving state to a normal state (power off→on) of the server according to the first embodiment of the present invention.

FIG. 8 is a diagram illustrating an expansion device that uses PCIe of a server according to a second embodiment of the present invention.

FIG. 9 is a diagram illustrating operation states of the expansion device of the server according to the second embodiment of the present invention.

FIG. 10 is a hardware configuration diagram illustrating an example of a computer that implements functions of the servers according to the first and second embodiments of the present invention.

FIG. 11 is a diagram for explaining power control in PCI-Express hot plugging.

FIG. 12 is a diagram for explaining power control of a laptop PC.

### MODES FOR CARRYING OUT THE INVENTION

Hereinafter, a server power control system and the like in a mode for carrying out the present invention (hereinafter referred to as “the present embodiment”) will be described with reference to the drawings.

### First Embodiment

### Overall Configuration

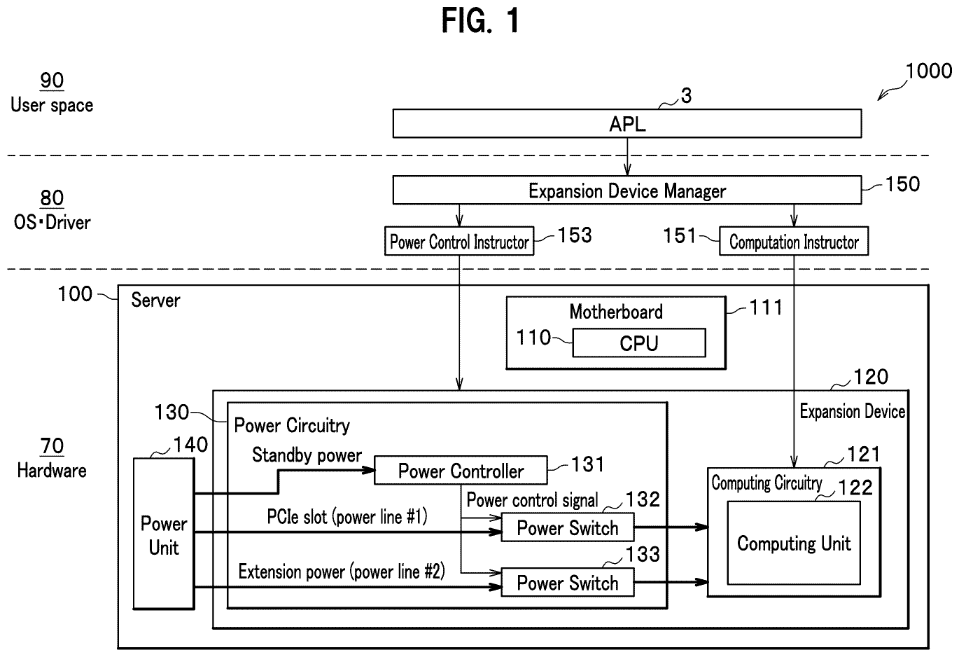

FIG. 1 is a schematic configuration diagram of a power control system according to a first embodiment of the present invention. FIG. 1 is a diagram illustrating a power control system in a layered structure.

As illustrated in FIG. 1, power control system 1000 has: server 100 deployed on hardware 70; expansion device manager 150, computation instructor 151, and power control instructor 153 on OS⋅driver 80; and an application program (APL 3), which is a user application or data high-speed transfer middleware arranged in user space 90.

Server 100 includes CPU 110 placed on motherboard 111, expansion device 120 having computing circuitry 121 and power circuitry 130, and power unit 140 that supplies power to power circuitry 130.

CPU 110 executes APL 3 (application program). CPU 110 is operated by supplying power from a power supply board (power supply unit; not illustrated) connected to the motherboard 111.

Expansion device 120 is supplied with power different from power supplied to CPU 110 and has a computing unit 122 (function unit) that adds functionality to server 100 (described in detail later).

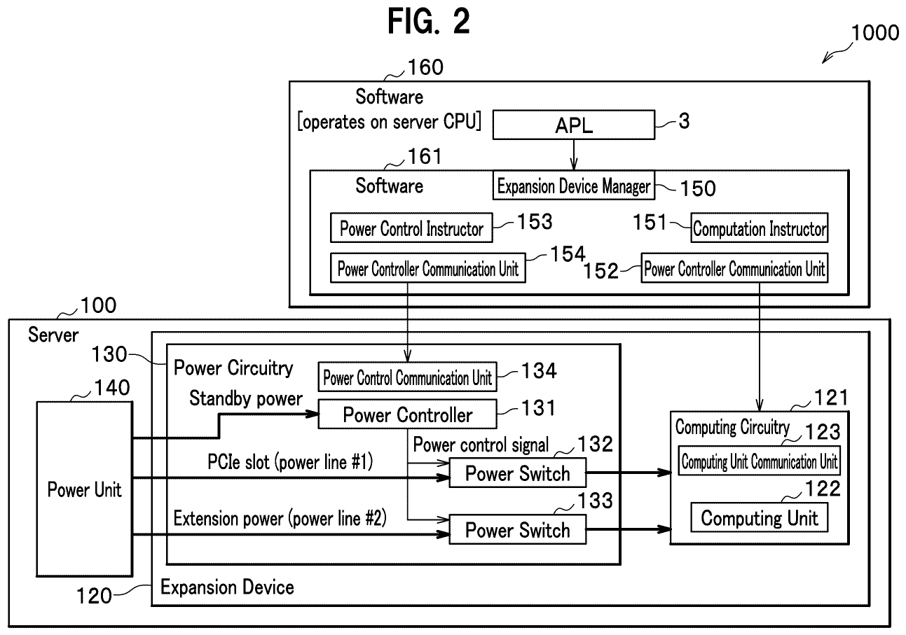

A computing unit 122 is included in computing circuitry 121. Note that computing circuitry 121 further includes computing unit communication unit 123 (FIG. 2) (described later).

Computing unit 122 is calculation unit hardware that performs specific computation at high speed based on an input from CPU 110. Specifically, computing unit 122 is an accelerator such as a GPU, an FPGA, or a PLD.

Although computing unit 122 is exemplified as a function unit that adds functionality to server 100 in the present embodiment, the function unit is not limited to the accelerator as long as the function unit adds functionality to server 100, and may be, for example, an NIC.

FIG. 2 is a diagram of power control system 1000 in FIG. 1 in the perspective of software 160 operating on CPU 110 of server 100.

CPU 110 of server 100 in FIG. 1 executes software 160 in FIG. 2.

Software 160 is implemented in a userland (here, user space 90) other than the kernel of the OS, and is executed by CPU 110. Although FIG. 2 illustrates an example in which software 160 is implemented in the userland, software 160 may be implemented in the kernel.

Software 160 has: APL 3, expansion device manager 150 with which APL 3 performs software control, computation instructor 151, power controller communication unit 152 that communicates with computing circuitry 121 of server 100 by software control of computation instructor 151, power control instructor 153, and power controller communication unit 154 that communicates with power circuitry 130 of server 100 by software control of power control instructor 153.

### APL 3

APL 3 is software that uses computing unit 122 included in expansion device 120. APL 3 uses expansion device 120 via expansion device manager 150.

### Expansion Device Manager 150

Expansion device manager 150 provides APL 3 with an Application Programming Interface (API) for using expansion device 120.

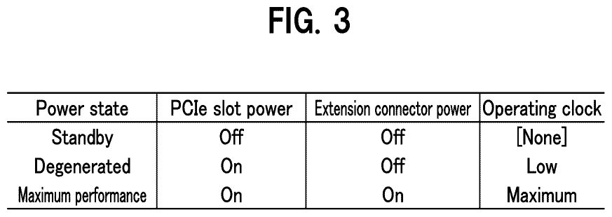

Expansion device manager 150 provides APL 3 with power saving of expansion device 120 as an API and changes the power state in response to an call to the API. Expansion device manager 150 defines three power states as illustrated in the table of FIG. 3, and APL 3 makes a designation of a power state.

FIG. 3 is a diagram illustrating examples of power states of the PCIe slot power supply and the extension connector power supply in the form of a table.

As illustrated in FIG. 3, in a case where the power state of the expansion device is “Maximum performance”, the PCIe slot power supply is “On”, the extension connector power supply is “On”, and the operating clock is “Maximum”.

In a case where the power state of the expansion device is “Standby”, the PCIe slot power supply is “Off”, the extension connector power supply is “Off”, and the operating clock is “None”.

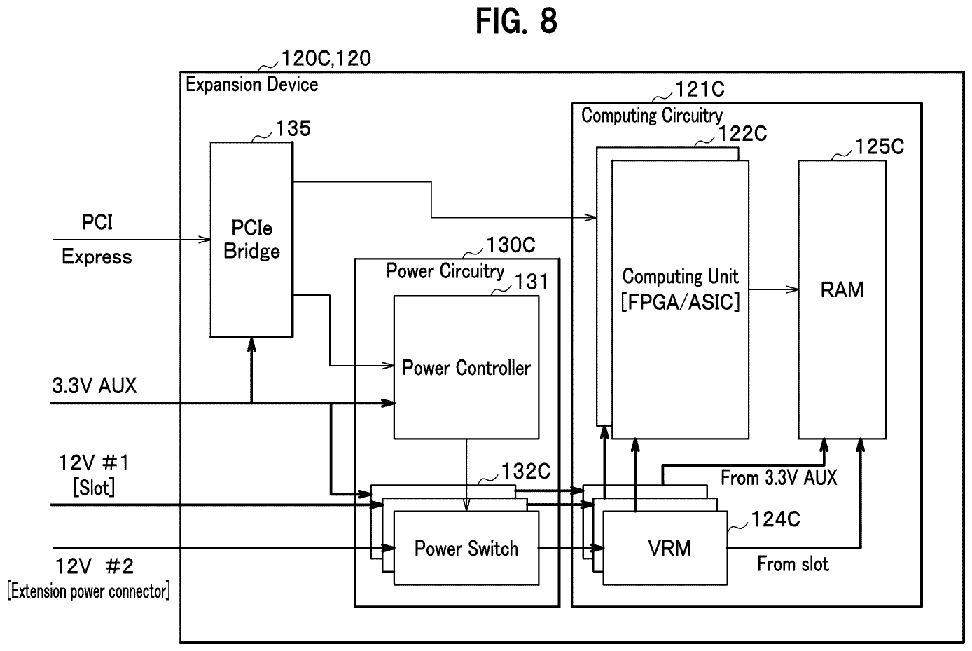

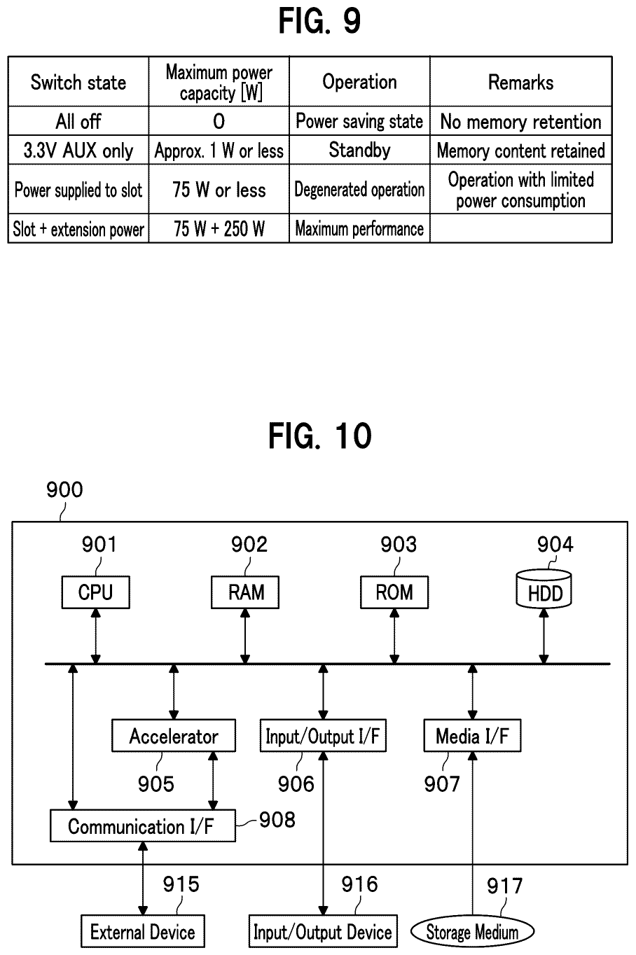

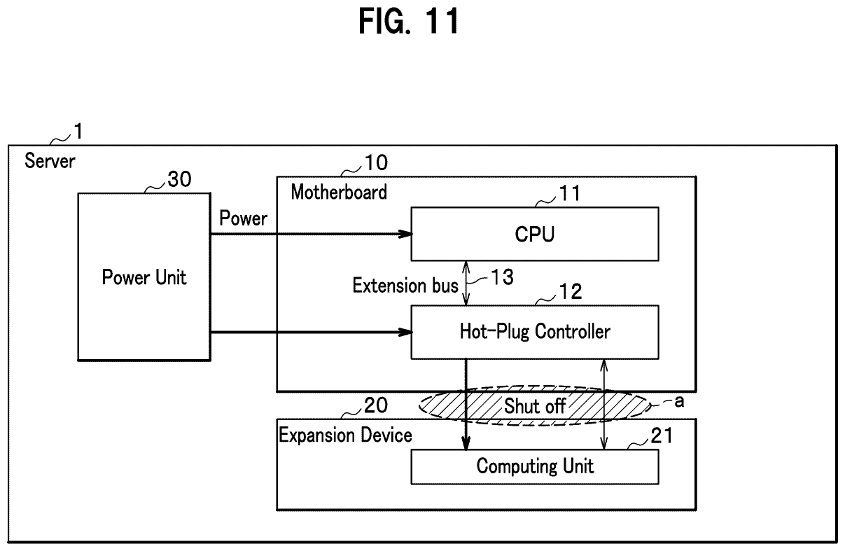

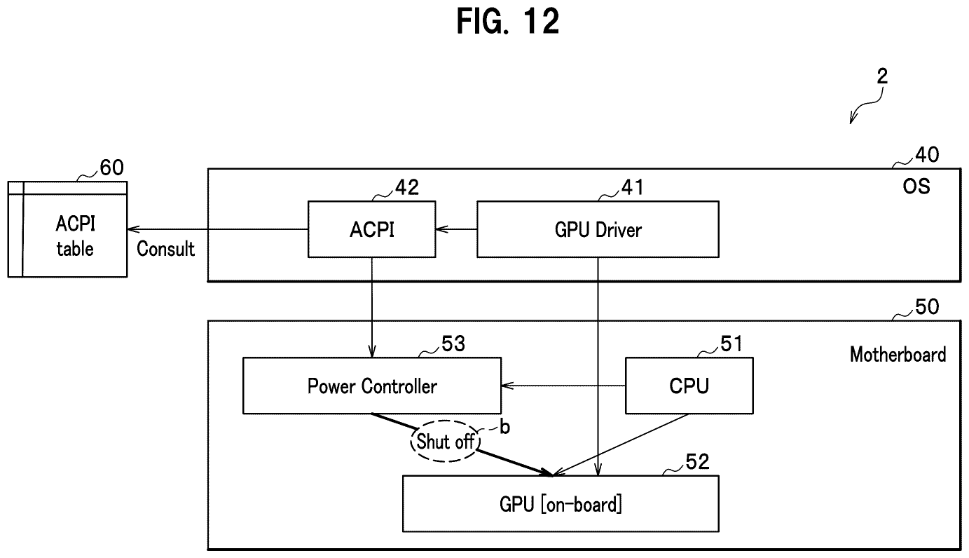

In a case where the power state of the expansion device is “Degenerated”, the PCIe slot power supply is “On”, the extension connector power supply is “Off”, and the operating clock is “Low”. Note that the degenerated operation will be described later with reference to FIGS. 8 and 9.

Expansion device manager 150 disables computing circuitry 121 through a low-level driver in order to switch the device to a power saving state.

Expansion device manager 150 executes, in the order of computation instructor 151 and then power control instructor 153, device-unique processing which is called when changing the power state. Moreover, expansion device manager 150 issues an instruction to perform initialization by computation instructor 151, and issues an instruction to turn on/off the power of computing circuitry 121 by power control instructor 153.

### Computation Instructor 151

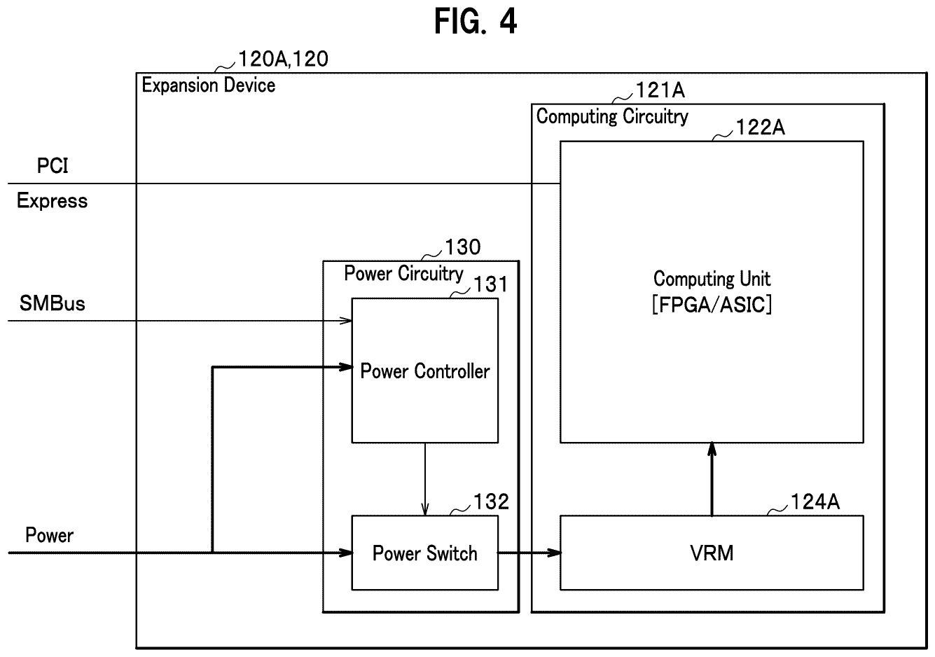

Computation instructor 151 transmits a power state change notification from expansion device manager 150 to power circuitry 130 via System Management Bus (SMBus) and performs processing for detecting abnormality of power circuitry 130. An implementation example of transmitting the power state change notification via the SMBus will be described later with reference to FIG. 4.

Computation instructor 151 is a device driver for handling computing circuitry 121 of expansion device 120. Computation instructor 151 performs control of starting/stopping/monitoring computation and the like and performs data transfers with a host machine.

In the present embodiment, computation instructor 151 issues an instruction to control computing circuitry 121 (executing computation, stopping computation, and reading status) and issues an instruction to move computation target data between server 100 and expansion device 120 by direct memory access (DMA).

Moreover, computation instructor 151 has a power saving function such as changing an operating clock specific to computing circuitry 121 and limiting maximum power consumption. These functions are called before power circuitry 130 shutting off the power supply at the time of changing the power state, to cause computation instructor 151 to perform switching to a degenerated operation that limits the maximum power consumption within a predetermined range, and when the power supply is shut off, saving data being computed and preparing for disconnection of computing circuitry 121.

### Power Control Instructor 153

Power control instructor 153 is a device driver that instructs power controller 131 of power circuitry 130 to perform power control. Power control instructor 153 instructs power controller 131 with an abstraction of an operation of issuing an instruction to turn on/off the power supply to computing circuitry 121.

### Expansion Device 120

Expansion device 120 is hardware which is connected to server 100 to extend the function of server 100 and in which a specific function is implemented. Expansion device 120 includes: computing circuitry 121 configured with hardware that achieves a target function; and power circuitry 130 that monitors and controls power supplied to computing circuitry 121. The power necessary for the operation of expansion device 120 may be directly supplied from connected server 100, or an external power supply may be directly connected to the main body of expansion device 120. Specifically, expansion device 120 includes a GPU, an FPGA, or an ASIC as computing circuitry 121, and includes an expansion card on which a microcontroller and load switches are mounted as a function corresponding to power circuitry 130.

It is assumed that expansion device 120 is implemented as an expansion card conforming to PCIe. Power unit 140 is implemented to supply standby power (3.3V AUX) to expansion device 120 as defined by PCIe-compliant standards, so that power is not interrupted regardless of the power state of server 100 or computing circuitry 121.

Power controller 131 of expansion device 120 is assumed to be a microcontroller connected to the SMBus of the PCIe slot. In response to an instruction from software 160 (FIG. 2) to change the power state, power controller 131 switches the on/off state of each power switch according to the definition of the table of FIG. 3.

As described above, in expansion device 120, power controller 131 exists independently of CPU 110 and the power supply unit supplying power to CPU 110 and supplies predetermined power to computing unit 122 regardless of the power states of CPU 110 and computing unit 122.

### Computing Circuitry 121

Computing unit 122 implements a target function as expansion device 120. Computing unit 122 is an accelerator such as a GPU, an FPGA, or an ASIC that can be used from APL 3.

### Power Circuitry 130

Power circuitry 130 converts the power from power unit 140 into predetermined power and supplies the predetermined power to computing circuitry 121.

Power circuitry 130 includes power controller 131, power lines #1 and #2, and power switches 132 and 133 that shut off power lines #1 and #2.

### Power Controller 131

In response to a request from APL 3, power controller 131 outputs power control signals for turning on/off power switches 132,133 on power lines #1, #2 for computing unit 122. Moreover, power controller 131 monitors the voltages applied to computing unit 122 and the power consumption.

Specifically, power controller 131, following an instruction from software 160 (FIG. 2), monitors, for each of power lines #1 and #2, on/off of the power supplied to computing circuitry 121, the voltage, the power consumption, or the like.

Power controller 131 switches on/off of the power supplied to computing circuitry 121 by switching the power control signals connected to power switches 132 and 133.

Power controller 131 is provided integrally with computing circuitry 121 on expansion device 120, but is a device independent of computing circuitry 121 in the perspective of server 100 and is always available even when the power supply is shut off so that computing circuitry 121 becomes unavailable from server 100.

### Power Switch 132, 133

Power switches 132 and 133 are each a load switch that switches between supply and shutoff of inputted power according to the state of the power control signal. Specifically, power switches 132 and 133 are implemented with a method using a mechanical relay, a method using a module called a solid state relay (SSR), a method using a discrete metal-oxide-semiconductor field effect transistor (MOSFET), or the like. Moreover, power switches 132 and 133 may be provided separately for each of power lines #1 and #2, or may be configured such that the power inputs are integrated to one and power controller 131 limits the power supply capacity that can be output from the input power supply capacity that can be input.

Power switches 132 and 133 are provided respectively on power lines #1 and #2 that supply power to computing unit 122, and switch between supply and shutoff of the inputted power in response to a control signal from power controller 131.

### Power Unit 140

Power unit 140 supplies necessary power to each component in server 100 from an input power supply. Specifically, power unit 140 corresponds to the power unit of the main body of server 100 and supplies power to the motherboard and the extension power connector of the PCIe expansion card corresponding to expansion device 120.

Power unit 140 supplies standby power to power controller 131.

Power unit 140 supplies PCIe slot power to computing circuitry 121 via power line #1 and power switch 132.

Power unit 140 supplies extension power to computing circuitry 121 via power line #2 and power switch 133.

### Implementation Example of Expansion Device 120

A description will be given of an implementation example of expansion device 120.

### Implementation Example 1

FIG. 4 is a diagram illustrating expansion device 120A that uses PCIe and SMBus. Expansion device 120A is an implementation example of expansion device 120 in FIGS. 1 and 2.

As illustrated in FIG. 4, expansion device 120A includes computing circuitry 121A and power circuitry 130.

Computing circuitry 121A includes: computing unit 122A including an FPGA/ASIC; and voltage regulator module (VRM) 124A. Computing unit 122A is power controlled by the PCIe hot plugging function from power controller communication unit 152 (FIG. 2). VRM 124A converts the power supplied from power circuitry 130 into a predetermined power supply voltage to be used by computing unit 122A and stably supplies the power.

Power circuitry 130 includes: power controller 131 including a microcontroller; and power switch 132.

Power controller 131 is supplied with power from power unit 140 (FIGS. 1 and 2), and is provided with an input of the SMBus from power controller communication unit 154 (FIG. 2).

The SMBus is a two-wire serial bus interface including a clock signal line and a data signal line. A device to be connected to the bus has a unique address. The SMBus allows peer-to-peer (P2P) communication between the devices based on the address.

In the present implementation example, a microcontroller corresponding to power controller 131 is connected to the SMBus, and computing circuitry 121A is connected to the host machine by PCIe.

When computing circuitry 121A is powered off according to a power saving state transition instruction given to power controller 131, PCIe becomes unavailable and it becomes possible only to issue an instruction to power controller 131 via the SMBus.

### Implementation Example 2

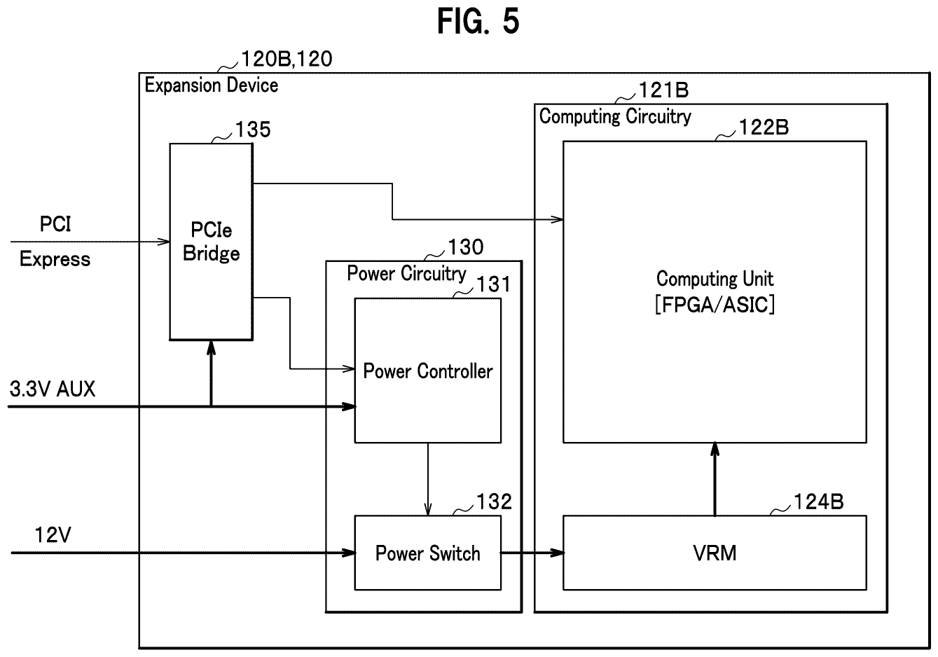

FIG. 5 is a diagram illustrating expansion device 120B that uses PCIe. Expansion device 120B is an implementation example of expansion device 120 in FIGS. 1 and 2.

As illustrated in FIG. 5, expansion device 120B includes computing circuitry 121B, power circuitry 130, and PCIe bridge 135.

Computing circuitry 121B includes: computing unit 122B including an FPGA/ASIC; and VRM 124B. Computing unit 122B is power controlled by the PCIe hot plugging function from PCIe bridge 135.

In the present implementation example, power controller 131 (microcontroller) is connected with PCIe, branched via the PCIe bridge 135.

Hereinafter, a description will be given of an operation of server 100 of power control system 1000 configured as described above.

### Procedure of Changing Power State

A description will be given of the procedure of changing the power state (“standby”, “maximum performance”, and “degenerated”).

### Standby (Power Off Computing Unit 122)

In FIGS. 1 and 2, when APL 3 instructs expansion device manager 150 to make a transition to a standby state, computation instructor 151 first terminates the computation being executed, saves temporary data, and makes preparations for removal of the PCIe endpoint of computing circuitry 121.

Subsequently, power control instructor 153, by an SMBus command (written into a register) to power controller 131 (microcontroller), instructs power circuitry 130 to transition to a standby state. As a result, on/off of the load switches of power switches 132 and 133 is switched to a state (all off) corresponding to “standby” of the power states illustrated in FIG. 3, and the power supply to computing circuitry 121 is shut off. At this time, computing circuitry 121 becomes unrecognizable from software 160 (FIG. 2).

### Maximum Performance (Power On)

When APL 3 instructs expansion device manager 150 to make a transition to a maximum performance state, power control instructor 153, by an SMBus command (written into a register) to power controller 131 (microcontroller), instructs power circuitry 130 to transition to a power-on state. As a result, on/off of the load switches of power switches 132 and 133 is switched to a state (all on) corresponding to “maximum performance” of the power states illustrated in FIG. 3, and the power is supplied to computing circuitry 121.

Subsequently, computation instructor 151 re-detects and initializes the PCIe endpoint of computing circuitry 121, saves temporary data (up to here, only at the time of transition from the power-off state), and switches the operating clock to the maximum.

### Degeneration

In order to ensure that the power consumption of computing unit 122 is equal to or less than the maximum power that can be supplied in the cases of transitioning from a maximum performance state to a degenerated state, the procedure of transitioning to a degenerated state is different between (1) a case of transition from a power-on state and (2) a case of transition from a power-off state.

### (1) Case of Transition From Power-On State

Computation instructor 151 switches the operating clock to a speed at which the power consumption is within a power that can be supplied from the slot, and, by an instruction to power circuitry 130 to transition to a degenerated state, put the load switches in a state where only the slot power supply is turned on.

### (2) Case of Transition From Power-Off State

After once transitioning to the maximum performance state described above, a transition is made to a degenerated state via the above-described (1) case of transition from power-on state. A description has been given of the procedure of changing the power state. Next, a description will be given of a processing example of expansion device management/use functions.

### Processing Example of Expansion Device Management/Use Function

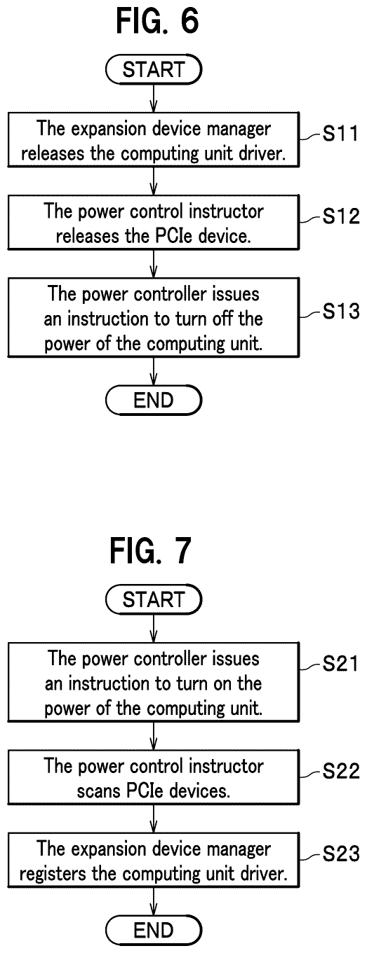

FIG. 6 is a flowchart illustrating a procedure of transition processing to a power saving state (power on→off).

In step S11, expansion device manager 150 releases the driver of computing unit 122. As a result, the device driver is terminated, and the resources transition into an unused state.

In step S12, power control instructor 153 releases the PCIe device of computing unit 122. Due to the release of the resources, the PCIe device becomes invisible to the OS.

In step S13, power controller 131 issues an instruction to turn off the power of computing unit 122 and finishes this flow. Deu to the power supply to the device of computing unit 122 being shut off, the PCIe link goes down, and a transition to a power saving state is made.

FIG. 7 is a flowchart illustrating a procedure of processing of restoration from a power saving state to a normal state (power off→on).

In step S21, power controller 131 issues an instruction to turn on the power of computing unit 122. As a result, the power of the device of computing unit 122 is restored, and the PCIe link goes up.

In step S22, power control instructor 153 scans PCIe devices. Power control instructor 153 detects a PCIe device and allocates resources.

In step S23, expansion device manager 150 registers the driver of computing unit 122 and finishes this flow. As a result, initialization of the PCIe device is completed.

### Second Embodiment

FIG. 8 is a diagram illustrating expansion device 120C that uses PCIe of a server according to a second embodiment of the present invention. Expansion device 120C is an implementation example of expansion device 120 in FIGS. 1 and 2.

The present embodiment is an example of an degenerated operation performed by controlling power lines #1 and #2 on a per-power-line basis.

As illustrated in FIG. 8, expansion device 120C includes computing circuitry 121C, power circuitry 130C, and PCIe bridge 135.

Computing circuitry 121C includes: computing units 122C each including an FPGA/ASIC; VRM 124C; and RAM 125C. Computing unit 122C is power controlled by the PCIe hot plugging function from the PCIe bridge 135.

Power circuitry 130C includes: power controller 131 including a microcontroller; and a plurality of power switches 132C.

Expansion device 120C is provided with the plurality of power switches 132C, a plurality of VRMs 124C, and a plurality of computing units 122C, and has a configuration in which a degenerated operation mode is added in addition to power on/off of the computing units 122C.

FIG. 9 is a diagram for explaining operation states of expansion device 120C in FIG. 8.

In a case where the switch state of power switches 132C is all off, the maximum power capacity [W] is 0, and the operation is “Power saving state”. In addition, in this case where the switch state is all off, there is no memory retention by RAM 125C.

In a case where the switch state of the power switches 132C is 3.3V AUX only, the maximum power capacity [W] is approximately 1 W or less, and the operation is “Standby”. In addition, in this case where the switch state is 3.3V AUX only, the memory content of the RAM 125C is retained.

In a case where the switch state of the power switches 132C is “Power supplied to slot”, the maximum power capacity [W] is approximately 75 W or less, and the operation is “Degenerated operation”. In addition, in this case where the switch state is “Power supplied to slot”, expansion device 120C operates with limited power consumption.

In a case where the switch state of the power switches 132C is Power Supplied to Slot and Extension Power Supplied, the maximum power capacity [W] is 75 W+250 W, and the operation is “Maximum performance”.

As described, expansion device 120C is provided with a power switch 132C for each power supply path (slot, extension power supply) or each computing unit 122C, and determines the computing unit(s) 122C to be operated according to necessary performance. Moreover, by causing the on-board memory to transition to the self-refresh mode using the standby power supply, a function of retaining the content of the memory while the power supply to computing circuitry 121C is stopped is implemented.

### Hardware Configuration

Server 100 according to each of the above-described embodiments is implemented by, for example, a computer 900 having the configuration illustrated in FIG. 10.

FIG. 10 is a hardware configuration diagram illustrating an example of computer 900 that implements the functions of server 100.

Computer 900 has CPU 901, RAM 902, ROM 903, HDD 904, accelerator 905, input/output interface (I/F) 906, media interface (I/F) 907, and communication interface (I/F) 908. Accelerator 905 corresponds to computing unit 122 of computing circuitry 121 of expansion device 120 of server 100 illustrated in FIGS. 1 and 2.

Accelerator 905 is a computing unit 122 (FIGS. 1 and 2) that processes at least one of data from communication I/F 908 or data from RAM 902 at high speed. Note that accelerator 905 may be of a type (look-aside type) that executes processing passed from CPU 901 or RAM 902 and then returns the execution result to CPU 901 or RAM 902. On the other hand, accelerator 905 may also be of a type (in-line type) that is interposed between communication I/F 908 and CPU 901 or RAM 902 and performs processing.

Accelerator 905 is connected to external device 915 via communication I/F 908. Input/output I/F 906 is connected to input/output device 916. Media I/F 907 reads and writes data from and to recording medium 917.

CPU 901 operates on the basis of a program stored in the ROM 903 or HDD 904 and controls each component of server 100 illustrated in FIGS. 1 and 2 by executing the program (also called as an application or an App as an abbreviation thereof) loaded to the RAM 902. In addition, the program may be distributed via a communication line or distributed by being recorded on recording medium 917 such as a CD-ROM.

ROM 903 stores a boot program to be executed by CPU 901 at the time of start-up of computer 900, a program depending on hardware of computer 900, and the like.

CPU 901 controls, via input/output I/F 906, input/output device 916 including an input unit such as a mouse or a keyboard and an output unit such as a display or a printer. CPU 901 acquires data from input/output device 916 and outputs generated data to input/output device 916 via input/output I/F 906. Note that a graphics processing unit (GPU) or the like may be used as a processor in conjunction with CPU 901.

HDD 904 stores a program to be executed by CPU 901, data to be used by the program, and the like. Communication I/F 908 receives data from another device via a communication network (e.g., network (NW)) and outputs the data to CPU 901, and transmits data generated by CPU 901 to another device via the communication network.

Media I/F 907 reads a program or data stored in recording medium 917 and outputs the program or data to CPU 901 via RAM 902. CPU 901 loads a program regarding target processing from recording medium 917 onto RAM 902 via media I/F 907 and executes the loaded program. Recording medium 917 is an optical recording medium such as a digital versatile disc (DVD) or a phase change rewritable disk (PD), a magneto-optical recording medium such as a magneto optical disk (MO), a magnetic recording medium, a conductor memory tape medium, a semiconductor memory, or the like.

For example, in a case where computer 900 functions as server 100 configured as a device according to the present embodiment, CPU 901 of computer 900 implements the function of server 100 by executing a program loaded on RAM 902. Moreover, HDD 904 stores data retained in RAM 902. CPU 901 reads the program regarding the target processing from recording medium 917 and executes the program. Additionally, CPU 901 may read the program regarding the target processing from another device via the communication network.

### Effects

As described above, server 100 includes: CPU 110 (FIG. 1) that executes an application program (APL 3); and expansion device 120 (FIGS. 1 and 2) that is supplied with power different from the power supplied to CPU 110 and has a function unit (computing unit 122) for adding a function to server 100 (FIGS. 1 and 2), wherein expansion device 120 includes: power controller 131 that performs on/off control of the function unit separately for power lines #1 and #2 in response to a request from the application program; and power switches 132,133 provided on power lines #1, #2, which supply power to the function unit, to switch between supply and shutoff of inputted power upon reception of a control signal from power controller 131.

With this configuration, server 100 (FIGS. 1 and 2) completes the power control within expansion device 120 according to the request from the application program by using power controller 131 and power switches 132 and 133 provided in expansion device 120. In other words, a power saving state completed within expansion device 120 is realized. As the power control is achieved by expansion device 120 alone, the power control of the function unit (computing unit 122) can be performed without depending on the specifications of computing circuitry 121 and server 100. As a result, server 100 can satisfy the requirement of “host machine independency”.

Moreover, server 100 (FIGS. 1 and 2) is able to perform power control according to a request (demand) from the application program by providing power controller 131 that allows the application program to turn on/off the power supplied to the function unit (computing unit 122) for each of power lines #1 and #2 in expansion device 120. That is, in server 100, only the power supply to the function unit (computing unit 122) in expansion device 120 is made independent, and power controller 131 performs on/off control individually for each of power lines #1 and #2 in response to a request (demand) from the application program. With this, server 100 can satisfy the requirement of “minimization of standby power consumption” by enabling power control from the application program and performing fine power control according to a request (demand) from the application program.

As a result, server 100 is able to reduce (ideally minimize) the power consumption of expansion device 120, without depending on the implementation of the server and while securing performance required from the application program.

In server 100 (FIGS. 1 and 2), the function unit (computing unit 122) is an accelerator that executes specific processing of the application program, or an NIC.

With this, server 100 (FIGS. 1 and 2) is able to perform power control according to a request (demand) from the application program regardless of whether the function unit is any one of an accelerator such as a GPU, an FPGA, or a PLD, or an NIC.

Server 100 (FIG. 2) includes motherboard 111 on which CPU 110 is arranged, and in expansion device 120, power controller 131 exists independently of the power supplied to CPU 110 placed on motherboard 111 and supplies predetermined power to computing unit 122 regardless of the power states of CPU 110 and computing unit 122.

With this, server 100 (FIG. 1) is able to complete the power control according to the request from the application program within expansion device 120 without being affected by the state of the power supplied to CPU 110, and is able to perform power control of the function unit (computing unit 122) without depending on the specifications of computing circuitry 121 and server 100.

In server 100 (FIGS. 1 and 2), expansion device 120B (FIG. 5) is implemented as an expansion card conforming to PCI-Express, power controller 131 is a microcontroller connected to SMBus of a PCI-Express slot, and power controller 131 supplies standby power defined in the PCI-Express standard to computing unit 122 regardless of the power states of CPU 110 and computing unit 122.

With this, in expansion device 120B (power controller 131), the microcontroller connected to the SMBus of the PCI-Express slot is able to perform power control according to the requests from the application program.

Server 100 (FIG. 1) has software 160 (FIG. 2) implemented in an OS or a userland and executed by CPU 110, and software 160 includes expansion device manager 150 (FIG. 2) that provides power saving of expansion device 120 to the application program as an API and issues an instruction regarding a power state to power controller 131 based on an API call by the application program.

Due to this configuration, with server 100 (expansion device manager 150) (FIG. 1), it becomes possible to facilitate and generalize implementation of a power control program by using API calls and execute the implementation easily.

Expansion device 120 (FIGS. 1 and 2) with computing unit 122 for adding a function to server 100 (FIGS. 1 and 2) includes: power controller 131 that performs on/off control of the function unit (computing unit 122) separately for power lines #1 and #2 in response to a request from an application program; and power switches 132,133 provided on power lines #1, #2, which supply power to the function unit, to switch between supply and shutoff of inputted power in response to a control signal from power controller 131.

With this configuration, expansion device 120 is able to perform power control of the function unit (computing unit 122) without depending on the specifications of computing circuitry 121 and server 100. Moreover, power controller 131 performs on/off control individually for each of power lines #1, #2 according to a request (demand) from the application program, so that expansion device 120 is able to perform fine power control according to the request (demand) from the application program. As a result, expansion device 120 is able to reduce (ideally minimize) the power consumption of expansion device 120, without depending on the implementation of server 100 and while securing performance required from the application program.

Expansion device 120B (FIG. 5) is implemented on server 100 as an expansion card conforming to PCI-Express, power controller 131 is a microcontroller connected to the SMBus of a PCI-Express slot, and power controller 131 supplies standby power defined in the PCI-Express standard to the function unit (computing unit 122) regardless of the power state of the function unit (computing unit 122).

With this configuration, in a case where expansion device 120B is implemented on server 100 as an expansion card conforming to PCI-Express, in power controller 131, the microcontroller connected to the SMBus of the PCI-Express slot performs power control according to requests from the application program.

Some or all of the above components, functions, processing units, processing means, and the like may be implemented by hardware, for example, by designing them in an integrated circuit. Moreover, the above components, functions, and the like may be implemented by software for interpreting and executing a program for causing a processor to implement the respective functions. Information such as a program, a table, and a file for implementing the respective functions can be held in a recording device such as a memory, a hard disk, or a solid state drive (SSD), or in a recording medium such as an integrated circuit (IC) card, a secure digital (SD) card, or an optical disc.

### REFERENCE SIGNS LIST

3 Application program (APL)
70 Hardware
80 OS Driver
90 User space
100 Server
111 Motherboard
110 CPU
120, 120A, 120B Expansion device
121, 121A, 121B Computing circuitry
122, 122A, 122B Computing unit (function unit)
124A, 124B VRM
130 Power circuitry
131 Power controller
132, 133 Power switch
135 PCIe bridge
140 Power unit
150 Expansion device manager
151 Computation instructor
152 Power controller communication unit
153 Power control instructor
154 Power controller communication unit
160 Software
1000 Power control system
#1, #2 Power line

1.-8. (canceled)

9. A server comprising:
a central processing unit (CPU) that executes an application program; and
an expansion device that is supplied with first power different from second power supplied to the CPU and has a function unit for adding a function to the server,
wherein the expansion device includes:
a plurality of power lines for supplying the expansion device with the first power, one or more power lines of the plurality of power lines used to supply power to the function unit;
a power controller configured to perform on/off control of the function unit separately for the one or more power lines in response to a request from the application program; and
one or more switches provided respectively on the one or more power lines, each of the one or more switches configured to switch between supply and shutoff of power inputted to the respective power line upon reception of a control signal from the power controller.

10. The server according to claim 9,
wherein the function unit is an accelerator that executes specific processing of the application program, or a network interface card (NIC).

11. The server according to claim 9, further comprising a motherboard on which the CPU is mounted,
wherein in the expansion device, the power controller exists independently of the second power supplied to the CPU and is configured to perform control to supply predetermined power to the function unit regardless of power states of the CPU and the function unit.

12. The server according to claim 9, wherein
the expansion device is implemented as an expansion card conforming to Peripheral Component Interconnect-Express (PCI-Express) standard,
the power controller is a microcontroller connected to a System Management Bus (SMBus) of a PCI-Express slot, and
the power controller is configured to perform control to supply standby power defined in PCI-Express standard to the function unit regardless of power states of the CPU and the function unit.

13. The server according to claim 9, further comprising software implemented in an operating system (OS) or a user space and executed by the CPU,
wherein the software includes an expansion device manager configured to provide a power saving function of the expansion device to the application program as an application programming interface (API) and issue an instruction regarding a power state to the power controller in response to an API call from the application program.

14. An expansion device with a function unit for adding a function to a server, the expansion device comprising:
a plurality of power lines for supplying the expansion device with power, one or more power lines of the plurality of power lines used to supply power to the function unit;
a power controller configured to perform on/off control of the function unit separately for the one or more power lines in response to a request from an application program, and
one or more switches provided respectively on the one or more power lines, each of the one or more switches configured to switch between supply and shutoff of power inputted to the respective power line in response to a control signal from the power controller.

15. The expansion device according to claim 14, wherein
the expansion device is implemented on the server as an expansion card conforming to Peripheral Component Interconnect-Express (PCI-Express) standard,
the power controller is a microcontroller connected to a System Management Bus (SMBus) of a PCI-Express slot, and
the power controller is configured to perform control to supply standby power defined in PCI-Express standard to the function unit regardless of a power state of the function unit.

16. A power control method for an expansion device with a function unit for adding a function to a server, the expansion device including: a power controller; a plurality of power lines for supplying the expansion device with power, one or more power lines of the plurality of power lines used to supply power to the function unit; and one or more switches respectively provided on the one or more power lines, the power control method comprising:
by the power controller, performing on/off control of the function unit separately for the one or more power lines in response to a request from an application program, by outputting a power control signal to each of the one or more switches; and
by each of the one or more switches, in response to the control signal, switching between supply and shutoff of power inputted to the respective power line.
